(19) United States
(12) Patent Application Publication
(10) Pub. No.: US 2009/0031635 A1
(43) Pub. Date: Feb. 5, 2009

(54) Window or door assembly having plastic frame members with magnetic weather seal

(75) Inventor: Mark R. Davis, Liberty Township, OH (US)

Correspondence Address: Alan F. Meckstroth;JACOX, MECKSTROTH & JENKINS, Suite 2, 2310 Far Hills Building, Dayton, OH, 45419-1575, US

(73) Assignee: Deceuninck North America, LLC

(21) Appl. No.: 11/879,147

(22) Filed: Jul. 16, 2007

(51) Int. Cl. E06B 7/16

(52) U.S. Cl. 49/478.1

(57) ABSTRACT

A window or door assembly includes a main frame formed from extrusions of rigid plastics material, and the main frame supports at least one movable sash frame also formed from extrusions of rigid plastics material and enclosing a glass or glazing panel. One of the sash frame members supports a first member of a permanent magnet assembly for movement with the sash frame, and the magnet assembly includes a second member supported between an inner wall and an outer wall of an adjacent main frame member. The second member of the magnet assembly is positioned to provide a magnetic attraction with the first member of the magnet assembly and through the inner wall of the main frame member to form a positive weather seal between the sash frame and the main frame when the sash frame and the glazing panel are in a closed position.

### BACKGROUND OF THE INVENTION

This invention relates to a window or door assembly having a movable sash frame enclosing a glass panel or glazing unit and which may be, for example, a horizontal sliding window or door assembly, or a casement or awning window assembly or a vertical sliding double or single hung window assembly. The latter assembly is disclosed in U.S. Pat. No. 6,826,871 which issued to the assignee of the present invention and the disclosure of which is herein incorporated by reference. In such a window assembly, a main window frame and one or more sash frames are formed from extrusions of rigid plastics material such as polyvinylchloride (PVC), and preferably, the corner portions of each frame are mitered and welded to form rigid and strong corner joints.

In window and door assemblies, it is known to attach exterior storm windows with magnetic strips, for example, as disclosed in U.S. Pat. No. 4,079,558, No. 4,387,541, and No. 4,592,280. As disclosed in these patents, single glass or glazing panels receive extruded plastic or vinyl sash frame members which carry strips of permanent magnetic materials. The magnetic strips are removably attached to other magnetic strips or ferrous metal strips which are attached by adhesive to the main window frame. The magnetic strips carried by the sash frame may be supported by longitudinally extending flexible bellow portions which may be extruded as portions of the sash frame members, for example, as shown in the '558 Patent and '180 Patent.

Similar type of magnetic seals have been proposed or used for forming weather seals between a sliding door or window assembly, for example, as disclosed in U.S. Pat. No. 4,922,658. As disclosed in this patent, the door or window sash frame members carry flexible bellow-like strips supporting permanent magnetic strips which slidably engage ferrous metal strips attached by adhesive to an adjacent sash frame member. Similarly, it is known to attach a permanent magnetic strip to the bottom portion of a horizontal bottom sash rail or member of a vertical sliding window sash of a single or double hung window. The horizontal magnetic strip contacts a ferrous metal strip attached by adhesive to the upper surface of the window frame sill member. The ferrous metal strip may then be painted to match the color of the sill member. However, the adhesively attached painted metal strip may separate from the sill in time, and may also trap dirt on the sill member.

### SUMMARY OF THE INVENTION

The present invention is directed to a window or door assembly including a main frame formed by a pair of horizontally spaced vertical or jamb members rigidly connected by a horizontal sill member and a horizontal head member. The main frame members are formed from extrusions of rigid plastics material with each member having an outer wall adapted to fit within a rough window opening of a building and integrally connected to a laterally spaced inner wall. At least one window unit includes a sash frame formed by vertical and horizontal sash frame members of extruded rigid plastics material and encloses at least one glass or glazing panel. The sash frame and glazing panel are supported by the main frame for vertical or horizontal movement between an open position and a closed position.

One of the sash frame members supports a first magnet member of a permanent magnet assembly for movement with the sash frame. The magnet assembly also includes a second magnet member supported between the inner wall and the outer wall of an adjacent member of the main frame. The second magnet member of the magnet assembly is positioned to provide a magnetic attraction with the first magnet member of the magnet assembly and through the inner wall of the adjacent main frame member to form a weather seal between the sash frame and the main frame when the sash frame and the glazing panel are in their closed position.

In the illustrated embodiment, the first magnet member of the permanent magnet assembly is supported by a flexible bellows extrusion retained within an undercut slot in the bottom of a horizontal sash frame member. The second magnet member of the permanent magnet assembly is retained within an undercut slot directly below the inner wall of the sill member.

Other features and advantages of the invention will be apparent from the following description, the accompanying drawing and the appended claims.

### BRIEF DESCRIPTION OF THE DRAWING

FIG. 1 is an elevational view of a single hung window assembly incorporating a permanent magnet assembly forming a weather seal in accordance with the invention; and

FIG. 2 is an enlarged fragmentary vertical section of the window assembly, taken generally on the line 2-2 of FIG. 1.

### DESCRIPTION OF THE ILLUSTRATED EMBODIMENT

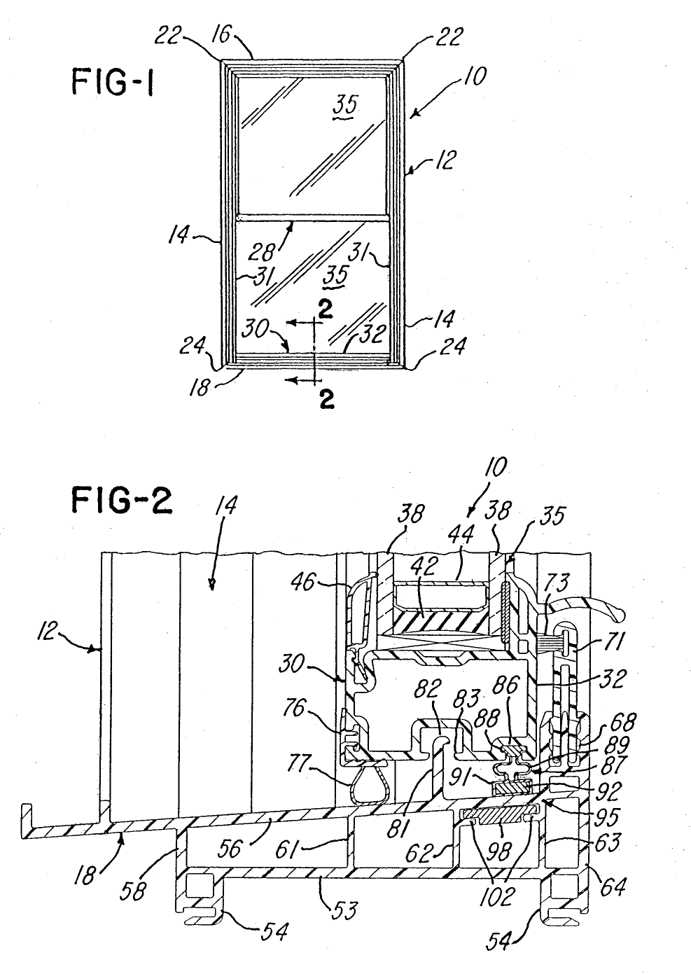

FIG. 1 illustrates a single hung window assembly 10 which includes a rectangular window main frame 12 formed by a pair of vertical jamb or frame members 14 connected by a horizontal head member 16 and a horizontal sill member 18. The frame members 14, 16 and 18 are formed from extrusions of rigid plastics material such as rigid polyvinylchloride. Preferably, the extruded sections have 45° mitered ends rigidly connected by welds to form mitered upper corner joints 22 and lower corner joints 24. The main frame 12 also includes a fixed extruded vinyl horizontal meeting rail or frame member 28 having an internal metal or rigid reinforcing member rigidly secured to the jamb members 14 by screws, as disclosed in above-mentioned U.S. Pat. No. 6,826,871.

The window assembly 10 also includes a sash frame 30 which includes vertical members 31 and horizontal members 32 fabricated or formed of extruded sections of rigid plastics or vinyl material and also having welded mitered corner joints. The sash frame 30 forms a movable window unit and encloses an insulated glass or glazing unit 35 having parallel spaced transparent glass panes or panels 38 (FIG. 2) bonded together by a resilient bonding material 42 surrounding an aluminum spacer frame 44, in a conventional manner. An extruded plastic removable glazing bead 46 contacts the glazing unit 35 and secures the glazing unit to the vertical and horizontal members 31 and 32 of the sash frame 30. As disclosed in the '871 Patent, the horizontal rail or frame member 28 has an upwardly projecting double wall flange and cooperates with a double wall flange on the head member 16 and double wall flanges on the vertical members 14 to receive and support a fixed upper glazing unit 35 which is also retained by a surrounding removable glazing beads 46 projecting into grooves within the sash frame members, as disclosed in the '871 Patent. While a single hung window assembly 10 is shown in FIGS. 1 & 2 to illustrate the present invention, it is to be understood that the invention may be incorporated on any window or door assembly having main frame members and movable sash frame members formed from extrusions of rigid plastics material.

Referring to FIG. 2, the extruded plastic sill member 18 includes an outer wall 53 having downwardly projecting double wall ribs 54 which are adapted to fit within a rough window opening of a building. The sill member 18 also includes a laterally spaced inner wall 56 which is inclined downwardly and outwardly and is integrally connected to the outer wall 53 by vertically extending ribs or walls 58, 61, 62, 63 and 64. The walls 63 and 64 project upwardly above the inner wall 56 and define a horizontally extending recess or groove 68 which receives an interchangeable vertical rib 71. A flexible weather strip 73 is supported by the rib 71 and forms a weather seal with the inner vertical surface of the bottom sash frame member 32. An extruded weather strip 76 having a flexible bulb-type seal 77 is mounted on the outer bottom corner portion of the bottom sash member 32 and engages the top surface of the inner wall 56 of the sill member 18 when the sash frame 30 is moved downwardly to its closed position, as shown in FIG. 2.

A vertical rib 81 projects upwardly from the top or inner wall 56 of the sill member 18 and has a hook portion 82 positioned to be engaged by a hook portion 83 on the sash frame member 32 when the window assembly 10 is subjected to an exterior negative pressure, for example, during a thunderstorm or hurricane, as described in the above '871 Patent. As also shown in the '871 Patent, each of the vertical frame members 14 and the head member 16 of the main frame 12 is extruded with inner and outer walls which correspond to and mate with the inner wall 56 and outer wall 53 of the sill member 18 so that opposite adjacent ends of the frame members may be miter-cut and welded together to provide the rigid corner joints 22 and 24.

In accordance with one embodiment of the present invention, the bottom surface of the bottom sash frame member 32 is extruded with an undercut groove 86 which receives and retains a permanent magnet member 87 including an extruded plastic T-shaped head portion 88, a flexible bellows portion 89 and an integral tubular portion 91 which surrounds a permanent magnet strip or member 92. Preferably, the elongated portions or members 88, 89, 91 and 92 of the magnet member 87 extend the entire width of the bottom sash frame member 32 between the jamb or frame members 14 and form part of a permanent magnetic seal assembly 95.

The magnetic assembly 95 also includes an elongated permanent magnet strip or member 98 which is located between the inner wall 56 and the outer wall 53 of the sill member 18 and is positioned adjacent the inner surface of the inner wall 56 directly under the magnet member 92 carried by the bottom sash frame member 32. As shown in FIG. 2, the magnet member 98 is retained adjacent the inner surface of the inner wall 56 by a pair of longitudinally and horizontally extending opposing ribs 102 which are extruded as an integral part of the sill member 18. The magnet member 98 may extend the full width of the sill member 18, or short sections of the magnet member 98 may be located adjacent opposite end portions of the sill member. If shorter sections of the magnet member 98 are used, a bonding adhesive may be used to secure the sections of the magnet member in place adjacent the end portions of the sill member 18. One source for the components of the magnetic seal assembly 95 and which have provided satisfactory results, is Holm Industries, Inc. in St. Charles, Ill. This company commonly produces dual durometer magnetic weather stripping commonly used on home appliances, commercial refrigeration and with metal doors.

As mentioned above, a window or door assembly constructed from extrusions of rigid plastics material, such as PVC, and incorporating a magnetic weather seal assembly constructed and installed in accordance with the invention provides desirable advantages. For example, the location of the permanent magnet or member 98 of the magnetic seal assembly 95 between the walls 53 and 56 of the sill member 18 and the position of the member 98 adjacent the inner surface of the inner wall 56 directly under the permanent magnet or member 92 of the assembly 95, provides an effective weather seal between the sash and the sill without attaching any magnet member or ferrous metal strip to the top surface of the inner wall 56. Also, the magnet or member 98 is protected from weather which contacts the upper surface of the sill member 18. While the strip of the magnet or member 98 may extend the full width of the sill member, sections of the strip may be used within opposite end portions of the sill member. When opposite end portions of the magnet or member 98 are held firmly against the top surface of the inner wall 56 of the sill member, the rigidity and weight of the magnet member 92 provides a continuous weather seal across the entire width of the sill member. As mentioned above, while the magnetic seal assembly 95 is illustrated to form a weather seal between a bottom sash frame member of a single hung window assembly and an adjacent sill member, the magnetic seal assembly 95 with the hidden magnet member 98 may also be used to form a weather seal between any member of a sash frame and an adjacent member of a main frame of a window or door assembly constructed of extruded sections of rigid plastics or PVC material.

While the form of window assembly herein described constitutes one embodiment of the invention, it is to be understood that the invention is not limited to this form of window assembly, and that changes may be made therein without departing from the scope and spirit of the invention as defined in the appended claims.

What is claimed is:

1. A window or door assembly comprising
a main frame including a pair of horizontally spaced vertical jamb members rigidly connected by a horizontal sill member and a horizontal head member,
all of said members of said main frame comprising extrusions of rigid plastics material with each member having an outer wall adapted to fit within a rough opening of a building and integrally connected to a laterally spaced inner wall,
at least one window unit including a sash frame having vertical and horizontal sash frame members comprising extrusions of rigid plastics material and enclosing at least one glazing panel,
said main frame supporting said sash frame and said glazing panel for movement between an open position and a closed position,
one of said sash frame members supporting a first member of a permanent magnet assembly for movement with said sash frame,
said permanent magnet assembly including a second member supported between said inner wall and said outer wall of one of said members of said main frame, and
said second member of said magnet assembly positioned to provide a magnetic attraction with said first member of said permanent magnet assembly and through said inner wall of said one member of said main frame to form a weather seal between said sash frame and said main frame when said sash frame and said glazing panel are in said closed position.

2. A window or door assembly as defined in claim 1 wherein said sash frame members include a horizontal bottom sash frame member, said first member of said permanent magnet assembly connected to said bottom sash frame member, and said second member of said permanent magnet assembly is positioned adjacent a bottom surface of said inner wall of said sill member.

3. A window or door assembly as defined in claim 1 wherein said inner wall of said one of said members of said main frame defines an undercut groove adjacent an inner surface of said inner wall, and said groove receives said second member of said magnet assembly.

4. A window or door assembly as defined in claim 1 wherein said first member and said second member of said permanent magnet assembly each comprises an elongated strip of permanent magnet material.

5. A window or door assembly as defined in claim 1 wherein said first member of said magnet assembly comprises a strip of permanent magnet material supported by a flexible bellows member connected to said one of said sash frame members.

6. A window or door assembly as defined in claim 1 wherein said second member of said magnet assembly comprises a strip of permanent magnet material and supported adjacent an inner surface of said inner wall of said one of said members of said main frame.

7. A window or door assembly comprising
a main frame including a pair of horizontally spaced vertical jamb members rigidly connected by a horizontal sill member and a horizontal head member,
all of said members of said main frame comprising extrusions of rigid plastics material with each member having an outer wall adapted to fit within a rough opening of a building and integrally connected to a laterally spaced inner wall,
at least one window unit including a sash frame having vertical and horizontal sash frame members comprising extrusions of rigid plastics material and enclosing at least one glazing panel,
said main frame supporting said sash frame and said glazing panel for vertical movement between an upper open position and a lower closed position,
said sash frame members including a horizontal bottom sash frame member supporting a first member of a permanent magnet assembly for movement with said sash frame,
said permanent magnet assembly including a second member supported between said inner wall and said outer wall of said sill member, and
said second member of said magnet assembly positioned to provide a magnetic attraction with said first member of said permanent magnet assembly and through said inner wall of said sill member to form a weather seal between said sash frame and said main frame when said sash frame and said glazing panel are in said closed position.

8. A window or door assembly as defined in claim 7 wherein said second member of said permanent magnet assembly is positioned adjacent a bottom surface of said inner wall of said sill member directly under said first member of said magnet assembly.

9. A window or door assembly as defined in claim 8 wherein said inner wall of said sill member defines an undercut groove adjacent said inner surface of said inner wall, and said groove receives said second member of said magnet assembly.

10. A window or door assembly as defined in claim 7 wherein said first member and said second member of said permanent magnet assembly each comprises an elongated strip of permanent magnet material.

11. A window or door assembly as defined in claim 7 wherein said first member of said magnet assembly comprises a strip of permanent magnet material supported by a flexible bellows member connected to said bottom sash frame member.

12. A window or door assembly as defined in claim 7 wherein said second member of said magnet assembly comprises a strip of permanent magnet material supported adjacent an inner surface of said inner wall of said sill member.
